(19) United States
(12) Patent Application Publication
(10) Pub. No.: US 2015/0170680 A1
(43) Pub. Date: Jun. 18, 2015

(54) DEVICES INCLUDING MAGNETIC READ SENSOR AND SHIELDS

(71) Applicant: SEAGATE TECHNOLOGY LLC, Cupertino, CA (US)

(72) Inventors: Declan Macken, Prior Lake, MN (US); Eric Singleton, Maple Plain, MN (US); Scott Stokes, Brooklyn Park, MN (US)

(21) Appl. No.: 14/574,829

(22) Filed: Dec. 18, 2014

Related U.S. Application Data
(60) Provisional application No. 61/917,505, filed on Dec. 18, 2013.

(51) Int. Cl. G11B 5/11; G11B 5/60

(52) U.S. Cl. CPC G11B 5/11; G11B 5/6082

(57) ABSTRACT

Devices having an air bearing surface (ABS), the device including a first read sensor; a first read sensor shield; and a first stray field shield, wherein the first read sensor shield is configured to shield at least the first read sensor from magnetic fields of the device, and the first stray field shield is configured to shield the first read sensor from stray environmental magnetic fields.

### PRIORITY

This application claims priority to U.S. Provisional Application No. 61/917,505 filed Dec. 18, 2013 entitled “DEVICES INCLUDING MAGNETIC READ SENSOR, READ SENSOR SHIELDS AND STRAY FIELD SHIELD”, the disclosure of which is incorporated herein by reference thereto.

### SUMMARY

Disclosed herein are devices having an air bearing surface (ABS), the device including a first read sensor; a first read sensor shield; and a first stray field shield, wherein the first read sensor shield is configured to shield at least the first read sensor from magnetic fields of the device, and the first stray field shield is configured to shield the first read sensor from stray environmental magnetic fields.

Also disclosed herein are devices having an air bearing surface (ABS), the device including a first read sensor and a second read sensor; a first read sensor shield and a second read sensor shield; and a first stray field shield, wherein the first and second read sensor shields are configured to shield the first read sensor and the second read sensor respectively, from magnetic fields of the device, and the first stray field shield is configured to shield the first read sensor and the second read sensor from stray environmental magnetic fields.

Also disclosed are devices having an air bearing surface (ABS), the device including a first read sensor and a second read sensor; a first read sensor shield configured to shield at least the first read sensor from magnetic fields of the device; a first stray field shield configured to shield the first read sensor and the second read sensor from stray environmental magnetic fields as a leading edge shield of the device; a second stray field shield configured to shield the first read sensor and the second read sensor from stray environmental magnetic fields as a trailing edge shield of the device; and a third stray field shield configured to shield the first read sensor and the second read sensor from stray environmental magnetic fields as a trailing edge shield of the device.

The above summary of the present disclosure is not intended to describe each disclosed embodiment or every implementation of the present disclosure. The description that follows more particularly exemplifies illustrative embodiments. In several places throughout the application, guidance is provided through lists of examples, which examples can be used in various combinations. In each instance, the recited list serves only as a representative group and should not be interpreted as an exclusive list.

### BRIEF DESCRIPTION OF THE FIGURES

The disclosure may be more completely understood in consideration of the following detailed description of various embodiments of the disclosure in connection with the accompanying drawings, in which:

FIG. 1A is a cross section of an illustrative disclosed device.

FIG. 1B is another cross section of the device depicted in FIG. 1A.

FIG. 1C is a cross section of an illustrative disclosed device that includes a single read sensor shield for two read sensors. illustrative

FIG. 2 is a schematic depiction of a portion of an illustrative device.

FIG. 3 is a cross section of a disclosed device that includes a single read sensor.

FIG. 4 is a cross section of a disclosed device that includes two read sensors.

The figures are not necessarily to scale. Like numbers used in the figures refer to like components. However, it will be understood that the use of a number to refer to a component in a given figure is not intended to limit the component in another figure labeled with the same number.

### DETAILED DESCRIPTION

Magnetic readers need to be shielded from magnetic fields from two different sources. The first source of magnetic fields is stray, uncontrolled, ill-defined, randomly located fields from the environment around the device that contains the magnetic reader. Such sources can include other electronic devices, the earth itself, and medical equipment for example. The second source of magnetic fields is those on the magnetic disc itself and includes the data bits that are not the current subject which the magnetic reader is addressed to. The two sources of magnetic fields produce very different types and strengths of magnetic fields.

In previous magnetic data readers, the shielding of these two different sources of magnetic fields was tied together. Disclosed devices decouple the shielding of these two different sources of magnetic fields and include a dedicated shield for each type of magnetic field.

Disclosed magnetic devices include a first shield that is designed to shield a magnetic read sensor from the random, uncontrolled, ill-defined magnetic fields and a second shield that is designed to shield a magnetic read sensor from at least one unwanted magnetic field from the magnetic disc itself. Because these shields are completely separate in form and function in disclosed devices, they can both be designed without taking the other type of fields into consideration.

In some embodiments, disclosed devices can include at least one magnetic read sensor, at least one read sensor shield, and at least one stray field shield. In some embodiments, disclosed devices can include a first magnetic read sensor, a second magnetic read sensor, a first read sensor shield, a second read sensor shield, and a first stray field shield.

Disclosed devices can include a single magnetic read sensor or more than one magnetic read sensor. The magnetic read sensor(s) can generally be configured to and can be operated to read data from magnetic storage media, for example a magnetic storage disc that may or may not be included with other magnetic storage discs as part of a hard disc drive (HDD). The magnetic read sensor(s) can be constructed in an unlimited number of configurations in which a plurality of magnetic and/or non-magnetic layers are capable of detecting magnetic data bits from an adjacent data storage medium (often across an air bearing surface (ABS)). Exemplary types of magnetic read sensors can include, for example giant magnetoresistive (GMR) sensors or tunneling magnetoresistive (TMR) sensors.

In some embodiments where disclosed devices include at least two magnetic read sensors, the device can be utilized for two dimensional magnetic recording (TDMR). TDMR (as well as multiple dimensional magnetic recording (MDMR)) utilize devices that include two (or more) individual magnetic read sensors to read data from magnetic media. The signals from the two distinct magnetic read sensors can then be convoluted, thereby allowing for smaller sized data bits to be recorded and read.

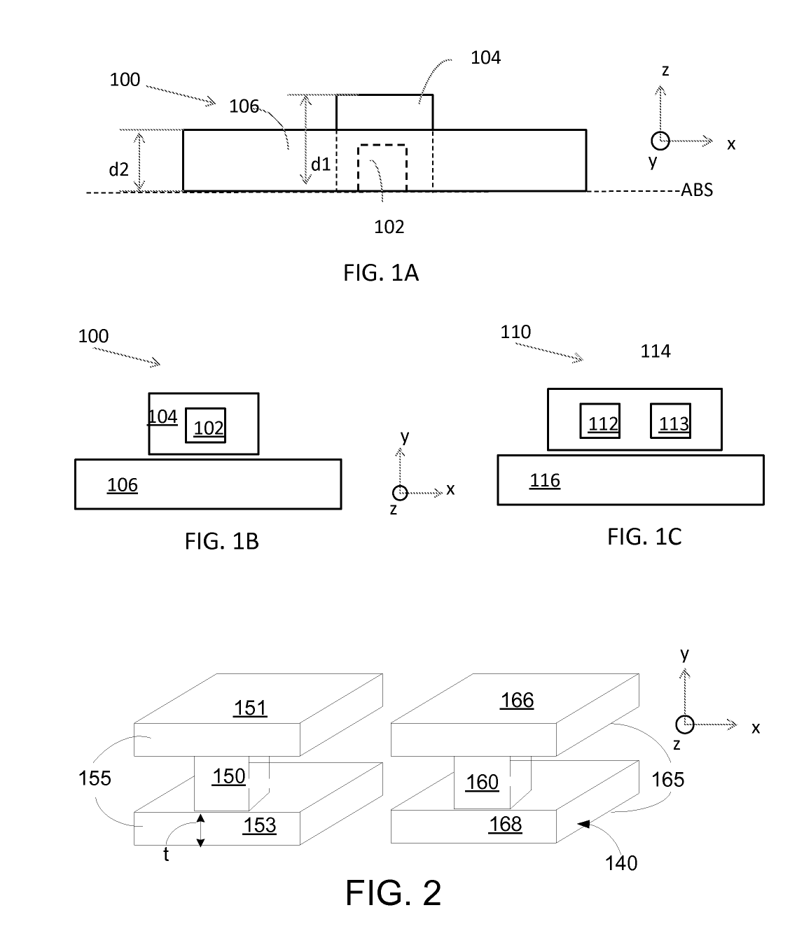

FIG. 1A shows an illustrative embodiment of a disclosed device. The device 100 can have an air bearing surface (ABS), and can include a magnetic read sensor 102, a read sensor shield 104, and a stray field shield 106. In some embodiments, the stray field shield 106 of the device 100 can be below the magnetic read sensor 102 and the read sensor shield 104, as seen in this particular embodiment, or stated another way, the stray field shield 106 can be more in the forefront in the y direction than the magnetic read sensor 102 and the read sensor shield 104. This can also be described as the stray field shield 106 serving a leading edge shield function. Although depicted as such in FIG. 1A, the stray field shield 106 need not be the same distance from the ABS along its entirety.

FIG. 1B shows another view of this illustrative device 100. As seen in this illustration, the stray field shield 106 is at the bottom of the device 100 and the magnetic read sensor 102 and the read sensor shield 104 are located thereon (but not necessarily directly thereon). The read sensors shield 104 depicted in FIG. 1B is shown completely surrounding the magnetic read sensor 102. The read sensor shield 104 is depicted this way only for the sake of convenience. In fact, the read sensor shield 104 could be composed of multiple structures which may or may not contact each other, may or may not be located adjacent more than one side or surface of the read sensor, may or may not be in the plane depicted in FIG. 1B, or any combination thereof. Read sensor shields capable of utilization in disclosed devices can have various configurations and attributes that have previously and may later on be found to be advantageous to shield a magnetic read sensor from magnetic fields from the magnetic data disc. As such, it should be recognized by one of skill in the art that the depiction of the read sensor shield 104 (and all other read sensor shields depicted herein) as entirely surrounding the read sensor is for illustration purposes only and should not be taken as limiting this disclosure in any way.

Disclosed devices include magnetic read sensors and read sensor shields. A read sensor shield can be described as shielding a magnetic read sensor (or read sensors) from at least one magnetic field from the magnetic media itself. More specifically, read sensor shields can be described as being configured to shield their individual magnetic read sensor(s) from magnetic fields of non-addressed, e.g., down track, up track, cross track, or any combination thereof magnetic bits (or tracks). As such, each magnetic read sensor in a disclosed device could be described as having a dedicated read sensor shield. In devices that include a first magnetic read sensor and a second magnetic read sensor therefore, there are a first read sensor shield (the read sensor shield dedicated to the first magnetic read sensor) and a second read sensor shield (the read sensor shield dedicated to the second magnetic read sensor).

In an alternative embodiment, an illustrative example of which is depicted in FIG. 1C, a single read sensor shield could be configured to shield more than one read sensor. As seen in FIG. 1C, the read sensor shield 114 in this embodiment is configured to shield both read sensor 112 and read sensor 113 from magnetic fields of non-addressed, e.g., down track, up track, cross track, or any combination thereof magnetic bits (or tracks). In such a device, the two read sensors share a read sensor shield as well as a stray field shield 116. However, as was the case in the embodiment of FIG. 1B, the two shields are configured to shield the sensors from fields that originate from different sources.

Individual read sensor shields can be made up of, in some embodiments two shield layers. The individual shield layers in such embodiments can have any configuration and/or shape that may be advantageous to provide shielding from magnetic fields of the magnetic disc. In some embodiments, shield layers may have straight walls. An example of this is depicted in FIG. 2.

In FIG. 2, a first read sensor 150 has an accompanying or dedicated read sensor shield or first read sensor shield 155. This illustrative first read sensor shield 155 can include a first shield layer 151 and a second shield layer 153. Also disclosed in this view is a second read sensor 160 that has an accompanying or dedicated read sensor shield or second read sensor shield 165. This illustrative second read sensor shield 165 can include a first shield layer 161 and a second shield layer 163. Both sets of the first shield layers and the second shield layers in this illustrative embodiment are substantially parallel and/or adjacent to the ABS of the device. It should also be noted that the illustrative example depicted by FIG. 2 can be applied similarly to a configuration where a single read sensor shield shields more than one read sensor by extending the first shield layer 151 and the second shield layer 153 so they are positioned adjacent both the first read sensor 150 and the second read sensor 160.

The read sensor shields and/or layers making them up (shield layers) can be described by their dimensions in various directions. As seen in FIG. 2, the thickness in the y direction of a first read shield layer 153 (for example) is given by t. Disclosed devices can offer advantages by allowing the thickness of the read sensor shields to be significantly smaller than prior devices, for example, they can have sub-micron thicknesses. FIG. 1A shows the depth dl of the read sensor shield 104 in the z direction.

The read sensor shield(s) can be made of a material or materials that can function to magnetically shield the individual read sensors from magnetic fields from the magnetic disc (other than the one being read). Illustrative materials can generally have a relatively low magnetostriction. Generally, the read sensor shield(s) are made of a relatively small amount of material, when considered in the context of the entire device, and therefore non-magnetic properties are less relevant. Their relatively small size (in comparison to the stray field shield) also makes it easier to control the domain structure of these shields. This can make them better read sensor shields.

The devices depicted in FIGS. 1A, 1B, and 1C also include a stray field shield 106 and 116 respectively. As discussed above, the stray shield field can be designed and configured to shield the magnetic read sensor from the uncontrolled, ill-defined, randomly located fields from the environment around the device that contains the magnetic read sensor. The uncontrolled, ill-defined, randomly located fields from the environment around the device that contains the magnetic reader can be referred to herein as “stray environmental magnetic fields”. A stray field shield in a device can then be configured to shield the magnetic read sensor(s) from stray environmental magnetic fields.

A stray field shield can generally be positioned along the ABS of the device. The device 100 includes a stray field shield 106 positioned adjacent the ABS. As seen in FIGS. 1B and 1C, the stray field shields 106 and 116 are closer to the leading edge or are in the forefront in the downtrack direction. The stray field shield can generally be made of any material that attracts magnetic flux, or described another way any material that is relatively highly permeable. In some embodiments, stray field shields can be made of materials such as iron (Fe), nickel (Ni), cobalt (Co), or alloys thereof. In some embodiments, stray field shields can be made of a material with a relative permeability of not less than 1.

Properties, other than magnetic permeability, can also be considered to choose a material(s) for stray field shields. For example, the coefficient of thermal expansion (CTE) of a material can be considered. The CTE of the material of the stray field shields can be important because of the relatively large bulk of the stray field shields. If the stray field shield(s) are made of a material with a CTE that is very different (or even different) from the CTE of the surrounding material, the device could suffer from undesirable effects with temperature increases. In some embodiments the material of the stray field shield(s) can desirably have a CTE that is within 30% of the CTE of the underlying substrate or surrounding material. In some embodiments the material of the stray field shield(s) can desirably have a CTE that is within 20% of the CTE of the underlying substrate or surrounding material. In some embodiments the material of the stray field shield(s) can desirably have a CTE that is within 10% of the CTE of the underlying substrate or surrounding material. In many instances, disclosed devices are configured on or within a larger substrate, typically AlTiC. The CTE of AlTiC is 7 ppm/degrees C. Therefore, in such embodiments, it may be advantageous that the stray field shield(s) be made of a material with a CTE within 30% (or 20%, or even 10%) of the CTE of AlTiC (7 ppm/degrees C). In some embodiments, stray field shield(s) could be made of a material that has a CTE from 5 ppm/degree C to 9 ppm/degree C. An illustrative material that could be utilized for stray field shields in a device having a AlTiC substrate is a 45:55 NiFe alloy.

A stray field shield(s) can also be made of more than one material. For example, a stray field shield could be made from a plurality of layers of different materials. In some embodiments, a plurality of materials having different magnetic moments could be layered to form a stray field shield. In such embodiments, the materials could be layered so that the magnetic moments of the materials decreases as you go away from the magnetic read sensor (see FIG. 1A, the magnetic moments of the materials would increase from the (leading edge of the bottom shield to the read sensor in the Y direction).

In some embodiments, stray field shields can have an arcuate shape. The arcuate shape of such stray field shields can be described as curving away from the ABS of the device. Stray field shields with arcuate shapes may be advantageous because they can prevent flux concentration leading to erasure.

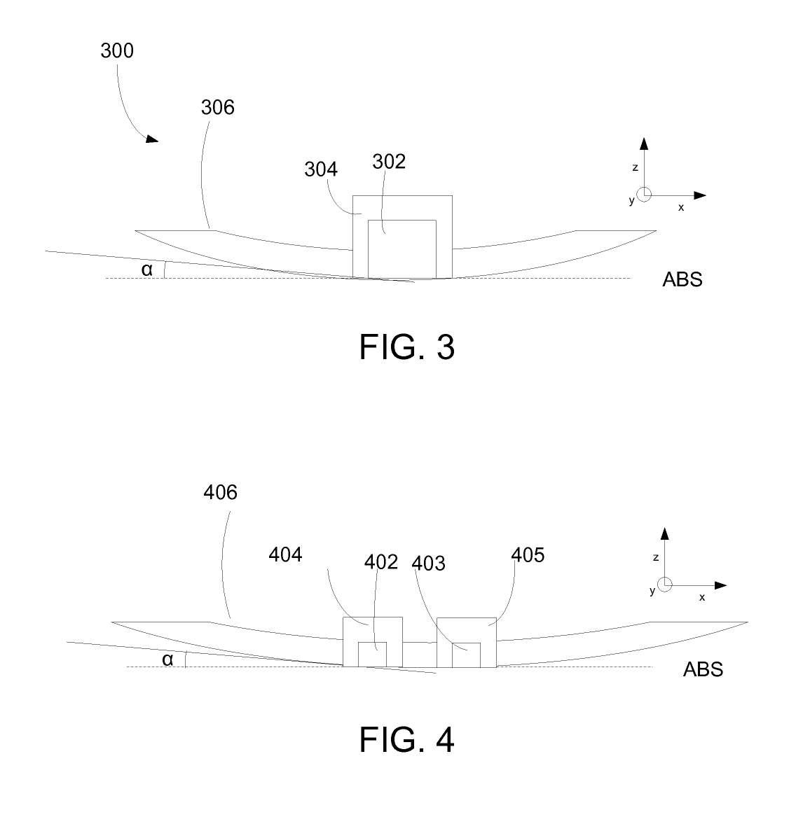

An example of an arcuately shaped stray field shield is depicted in FIG. 3. The device 300 in FIG. 3 includes a magnetic read sensor 302, a read sensor shield 304 and a stray field shield 306. The stray field shield 306 has an arcuate shape that curves away from the ABS. The degree of the arcuate shape can be described by the angle, α, that the front edge of the stray field shape 306 makes with the ABS. In some embodiments, the angle, α, can be as low as 0 degrees. In some embodiments, the angle, α, can be as low as 10 degrees. In some embodiments, the angle, α, can be as high as 30 degrees. In some embodiments, the angle, α, can be as high as 20 degrees. In some embodiments, the angle, α, can be 15 degrees.

In some embodiments, a dimension of a stray field shield and a dimension of a read sensor shield can be compared. As seen in the example of FIGS. 1A, and 3, the read sensor shields (104 and 304) extend farther in the z direction, than do the stray field shields (106 and 306). This can be relevant because the stray field shields have a higher demagnetization field than the read sensor shields; a smaller depth (in the z direction, see d1 and d2 in FIG. 1A) can increase the demagnetization field.

Embodiments of devices disclosed herein can also include more than one stray field shield. The embodiments, depicted so far include a stray field shield that is acting as a commonly referred to leading edge shield. Some disclosed embodiments can include a stray field shield on both the leading edge and the trailing edge of the magnetic read sensor(s). As such, some disclosed embodiments could be described as including both a stray field shield for a leading edge shield and a stray field shield for a trailing edge shield. It is also contemplated that stray field shields such as those described herein can be utilized adjacent the write pole of disclosed magnetic devices. In some embodiments, disclosed stray field shields could be utilized for a shield on the trailing edge of the write pole (as well as the leading edge of the magnetic read sensor(s) and/or the trailing edge of the magnetic read sensor(s)).

Some embodiments of disclosed devices can also include more than one read sensor. For example, the devices and concepts disclosed herein can be utilized in devices for TDMR. FIG. 4 shows a device 400 that includes a first read sensor 402, a second read sensor 403, a first read sensor shield 404, a second read sensor shield 405 and a stray field shield 406. Certain characteristics of the read sensors shields and the stray field shield can be such as was described above, for example. The distance between the two read sensors 402 and 403 along the x direction may be dictated at least in part by the particular configuration of the TDMR platform that is being utilized. Embodiments that include more than one read sensor can also optionally include more than one stray field shield (for example as a trailing edge shield of the magnetic read sensors, a trailing edge shield of the write pole, or a combination thereof).

It should also be noted that the device of FIG. 4 could be modified to exemplify a configuration where a single read sensor shield is configured to shield both the first read sensor 402 and the second read sensor 403 by having the first read sensor shield 404 and the second read sensor shield 405 be a single shield structure that is configured to shield both the read sensors.

All scientific and technical terms used herein have meanings commonly used in the art unless otherwise specified. The definitions provided herein are to facilitate understanding of certain terms used frequently herein and are not meant to limit the scope of the present disclosure.

As used in this specification and the appended claims, “top” and “bottom” (or other terms like “upper” and “lower”) are utilized strictly for relative descriptions and do not imply any overall orientation of the article in which the described element is located.

As used in this specification and the appended claims, the singular forms “a”, “an”, and “the” encompass embodiments having plural referents, unless the content clearly dictates otherwise.

As used in this specification and the appended claims, the term “or” is generally employed in its sense including “and/or” unless the content clearly dictates otherwise. The term “and/or” means one or all of the listed elements or a combination of any two or more of the listed elements.

As used herein, “have”, “having”, “include”, “including”, “comprise”, “comprising” or the like are used in their open ended sense, and generally mean “including, but not limited to”. It will be understood that “consisting essentially of”, “consisting of”, and the like are subsumed in “comprising” and the like. For example, a conductive trace that “comprises” silver may be a conductive trace that “consists of” silver or that “consists essentially of” silver.

As used herein, “consisting essentially of,” as it relates to a composition, apparatus, system, method or the like, means that the components of the composition, apparatus, system, method or the like are limited to the enumerated components and any other components that do not materially affect the basic and novel characteristic(s) of the composition, apparatus, system, method or the like.

The words “preferred” and “preferably” refer to embodiments that may afford certain benefits, under certain circumstances. However, other embodiments may also be preferred, under the same or other circumstances. Furthermore, the recitation of one or more preferred embodiments does not imply that other embodiments are not useful, and is not intended to exclude other embodiments from the scope of the disclosure, including the claims.

Also herein, the recitations of numerical ranges by endpoints include all numbers subsumed within that range (e.g., 1 to 5 includes 1, 1.5, 2, 2.75, 3, 3.80, 4, 5, etc. or 10 or less includes 10, 9.4, 7.6, 5, 4.3, 2.9, 1.62, 0.3, etc.). Where a range of values is “up to” a particular value, that value is included within the range.

Use of “first,” “second,” etc. in the description above and the claims that follow is not intended to necessarily indicate that the enumerated number of objects are present. For example, a “second” substrate is merely intended to differentiate from another infusion device (such as a “first” substrate). Use of “first,” “second,” etc. in the description above and the claims that follow is also not necessarily intended to indicate that one comes earlier in time than the other.

Thus, embodiments of devices including magnetic read sensor and shields are disclosed. The implementations described above and other implementations are within the scope of the following claims. One skilled in the art will appreciate that the present disclosure can be practiced with embodiments other than those disclosed. The disclosed embodiments are presented for purposes of illustration and not limitation, and the present disclosure is limited only by the claims that follow.

1. A device having an air bearing surface (ABS), the device comprising:
a first read sensor;
a first read sensor shield; and
a first stray field shield,
wherein
the first read sensor shield is configured to shield at least the first read sensor from magnetic fields of the device, and
the first stray field shield is configured to shield the first read sensor from stray environmental magnetic fields.

2. The device according to claim 1, wherein the first stray field shield has an arcuate shape that curves away from an air bearing surface of the device.

3. The device according to claim 2, wherein the first stray field shield has an angle of about 10 to about 20 degrees away from the ABS.

4. The device according to claim 1, wherein the first stray field shield comprises a material that has a relative permeability of at least about 1.

5. The device according to claim 1, wherein the material of the first stray field shield has a coefficient of thermal expansion that is within about 20% of the coefficient of thermal expansion of the surrounding material of the device.

6. The device according to claim 1, wherein the first stray field shield comprises a material that has a coefficient of thermal expansion from about 5 to about 9 ppm/° C.

7. The device according to claim 1, wherein the first read sensor shield comprises a material that has a low magnetostriction.

8. The device according to claim 1 further comprising a second read sensor, and wherein the first read sensor shield is configured to shield both the first and second read sensors from magnetic fields of the device.

9. The device according to claim 1 further comprising a second read sensor and a second read sensor shield configured to shield the second read sensor from magnetic fields of the device.

10. The device according to claim 1, wherein the first stray field shield is functioning as a leading edge shield of the device.

11. The device according to claim 1 further comprising a second stray field shield.

12. The device according to claim 11, wherein the second stray field shield is functioning as a trailing edge shield for the device.

13. The device according to claim 12, wherein the device further comprises:
a magnetic writer positioned adjacent the first read sensor along the ABS of the device, the magnetic writer comprising a first and second pole, with the first pole being closer to the first read sensor than the second pole,
and wherein the second stray field shield is adjacent the second pole.

14. The device according to claim 13 further comprising a third stray field shield, wherein the third stray field shield is functioning as a trailing edge shield for the magnetic writer of the device.

15. A device having an air bearing surface (ABS), the device comprising:
a first read sensor and a second read sensor;
a first read sensor shield and a second read sensor shield; and
a first stray field shield,
wherein
the first and second read sensor shields are configured to shield the first read sensor and the second read sensor respectively, from magnetic fields of the device, and
the first stray field shield is configured to shield the first read sensor and the second read sensor from stray environmental magnetic fields.

16. The device according to claim 15, wherein the first stray field shield has an angle of about 10 to about 20 degrees away from the ABS.

17. The device according to claim 15, wherein the material of the first stray field shield has a coefficient of thermal expansion that is within about 20% of the coefficient of thermal expansion of the surrounding material of the device.

18. The device according to claim 15, wherein the first stray field shield comprises a material that has a coefficient of thermal expansion from about 5 to about 9 ppm/° C.

19. The device according to claim 15, wherein the first read sensor shield and the second read sensor shield comprise a material or materials that have a low magnetostriction.

20. A device having an air bearing surface (ABS), the device comprising:
a first read sensor and a second read sensor;
a first read sensor shield configured to shield at least the first read sensor from magnetic fields of the device;
a first stray field shield configured to shield the first read sensor and the second read sensor from stray environmental magnetic fields as a leading edge shield of the device;
a second stray field shield configured to shield the first read sensor and the second read sensor from stray environmental magnetic fields as a trailing edge shield of the device; and
a third stray field shield configured to shield the first read sensor and the second read sensor from stray environmental magnetic fields as a trailing edge shield of the device.
